(19) United States
(12) Patent Application Publication
(10) Pub. No.: US 2025/0223669 A1
(43) Pub. Date: Jul. 10, 2025

(54) RARE EARTH PRODUCTION FROM COAL FEEDSTOCKS

(71) Applicant: University of Wyoming, Laramie, WY (US)

(72) Inventors: Richard HORNER, Laramie, WY (US); Shelbi HRKACH, Laramie, WY (US); David BELL, Laramie, WY (US); Davin BAGDONAS, Laramie, WY (US); Trina PFEIFFER, Laramie, WY (US)

(73) Assignee: University of Wyoming, Laramie, WY (US)

(21) Appl. No.: 18/850,975

(22) PCT Filed: Mar. 28, 2023
(86) PCT No.: PCT/US2023/065019

§ 371 Date: Sep. 25, 2024

Related U.S. Application Data
(60) Provisional application No. 63/324,553, filed on Mar. 28, 2022.

(51) Int. Cl. C22B 59/00; C22B 3/16; C22B 3/44; C22B 7/00

(52) U.S. Cl. CPC C22B 59/00; C22B 3/165; C22B 3/44; C22B 7/001; C22B 7/007

(57) ABSTRACT

In one embodiment, a method for extracting rare earth elements from coal includes preparing a coal-based intermediate product from a coal feedstock sourced from available natural occurring material associated with coal mining, wherein the a coal-based intermediate product has not been generated through the process of combustion: contacting the coal-based intermediate product with a weak acid; and extracting at least some rare earth elements from the coal-based intermediate product via the weak acid to produce a rare earth extract. The coal-based intermediate may be produced via a combination of pyrolysis and solvent extraction.

### CROSS-REFERENCE TO RELATED APPLICATIONS

This application claims the benefit of priority to U.S. Provisional Patent Application No. 63/324,553, filed Mar. 28, 2022, which is hereby incorporated by reference in its entirety.

### BACKGROUND OF INVENTION

Rare earth elements (REEs) are integral to high technology devices such as smart phones, digital cameras, magnets, energy systems, electric vehicles, computer parts, semiconductors, and the like. Ever-increasing growth of these applications in turn causes ever-increasing demand for rare earth elements, thus straining global supply. The need to find additional REE sources is paramount.

Furthermore, current methods of mining, refining, reusing and recycling of REEs have serious environmental and health costs. For example, low-level radioactive tailings resulting from the occurrence of thorium and uranium in rare-earth element ores presents environmental and health concerns during extraction and processing. Furthermore, current methods of extracting REEs from mined ores often involves the use of highly corrosive and hazardous strong acids, the responsible disposal of which may render the process economically unfeasible.

REEs are often found in relatively high concentrations in and around coal seams, especially associated with the overburden and underburden directly adjacent to a coal seam. Such characteristics present the opportunity to synergize coal extraction operations with REE production.

Fly ash, the product of coal combustion, is a recognized potential coal-based feedstock from which to extract REEs. However, while fly ash is a plentiful resource with more concentrated REEs than raw coal itself, the high temperatures at which fly ash is generated leads to the REEs being contained in a glassy or vitrified state, making their recovery difficult or impractical using more environmentally friendly and less harmful chemical processes than are currently utilized.

Thus, it can be seen from the foregoing that additional REE natural resources associated with coal mining-currently untapped, together with improved systems and methods for rare earth element recovery, extraction, and production from coal feedstocks are needed.

### SUMMARY OF THE INVENTION

Disclosed herein are systems and methods to extract and recover REEs from new sources of coal-based intermediate products. The disclosed systems and methods may avoid many of the environmental and health issues heretofore encountered with REE production of the prior art. The processes disclosed avoid combustion of the coal feedstock altogether, but may involve mild thermal treatment such as pyrolysis as part of the coal-based feedstock preparation step. The pyrolysis of the present disclosure occurs at substantially lower temperatures than experienced in industrial coal combustion processes, such as used in electricity generation and power plants, which is a ready source of fly ash. It has been discovered that by avoiding high temperature processing of the coal feedstock, the REEs may be extracted from the coal-based intermediate products, under certain conditions, via environmentally friendly weak acids which are capable of extraction and recovery (of REEs present) in a more deliberate and discrete way. In one embodiment, the coal-based intermediate product is based upon naturally occurring high REE content resources associated with coal mining.

The disclosed systems and methods contemplate preparing a coal-based intermediate that has been primed for REE extraction. Preparing the coal-based intermediate product may involve, for example, one or more of: a particle size reduction, a pyrolysis step, and/or a solvent extraction step and/or a combined solvent extraction and pyrolysis step.

In some embodiments, preparation of the coal-based intermediate may include improving the hydrophobic/hydrophilic surface characteristics of the feedstock to ensure saturation by the acids leading to improved and more economic extraction of REEs, e.g., using butanol and/or methanol etc.

In one embodiment, a method for extracting rare earth elements from coal may comprise preparing a coal-based intermediate product from a coal feedstock, wherein the coal-based intermediate product has not been generated through the process of combustion; contacting the coal-based intermediate product with a weak acid; and extracting at least some REEs from the coal-based intermediate product via the weak acid to produce a rare earth concentrated extract.

In some embodiments, weak acid extraction may include contacting the coal-based intermediate with an oxidizer.

In some embodiments more than one weak acid may be deployed as a single concentrate or in series.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1: REE concentration (mineral matter basis) in a 21 m (70 ft) core sample from a coal mine near Gillette, WY. The left side of the graph is the top of the coal seam, and the right side is the bottom of the coal mine.

FIG. 2: REEs remaining in the solid phase during leaching of Codero Rojo coal with 1 M HCl at room temperature.

FIG. 3: REE content of raw Cordero Rojo Coal.

FIG. 4: REE content in each source.

FIG. 5: Percent recovery of heavy REEs (Tb—Lu) over time for each acid.

FIG. 6: Percent recovery of Total REEs over time for each acid.

FIG. 7: Extraction results for various coal feedstock particle size preparations.

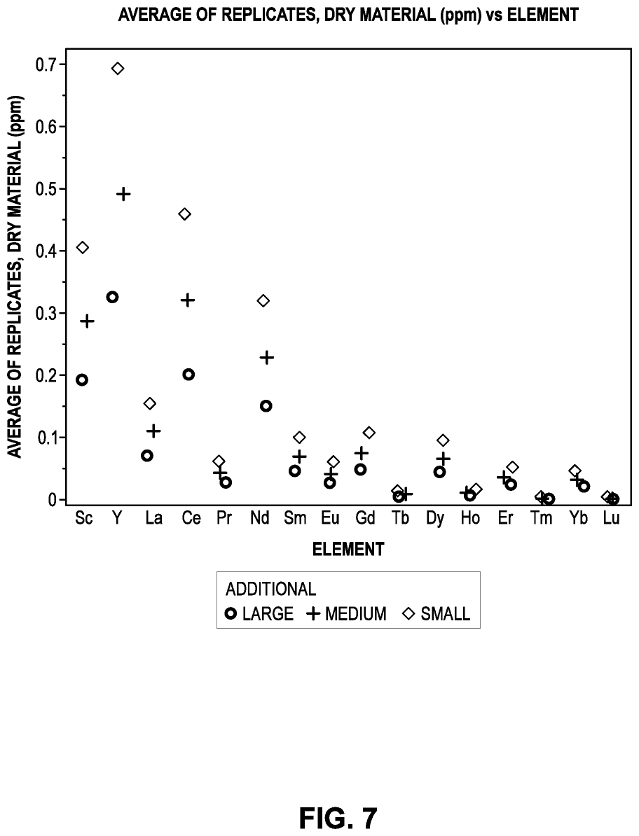

FIG. 8: REE extraction amounts at various temperatures.

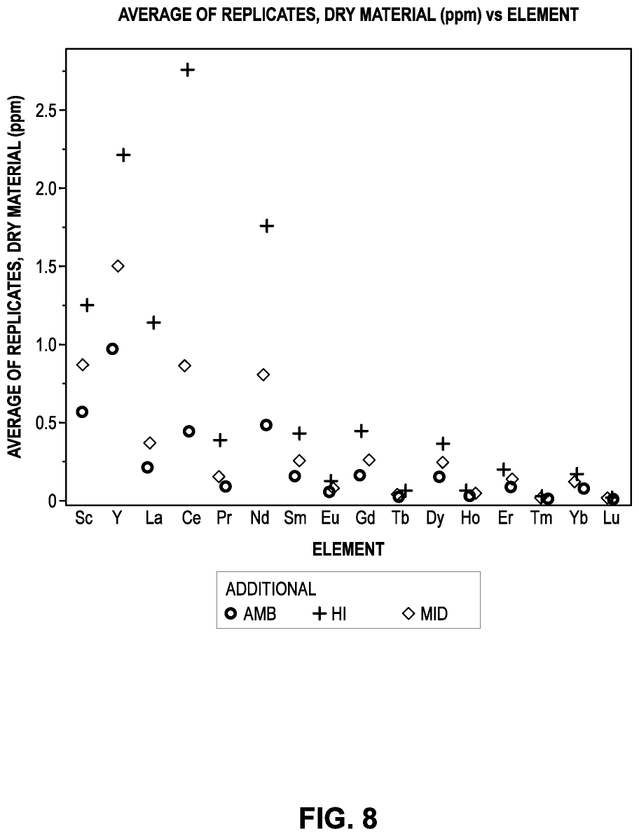

FIG. 9: REE extraction results for various coal-based feedstock sources.

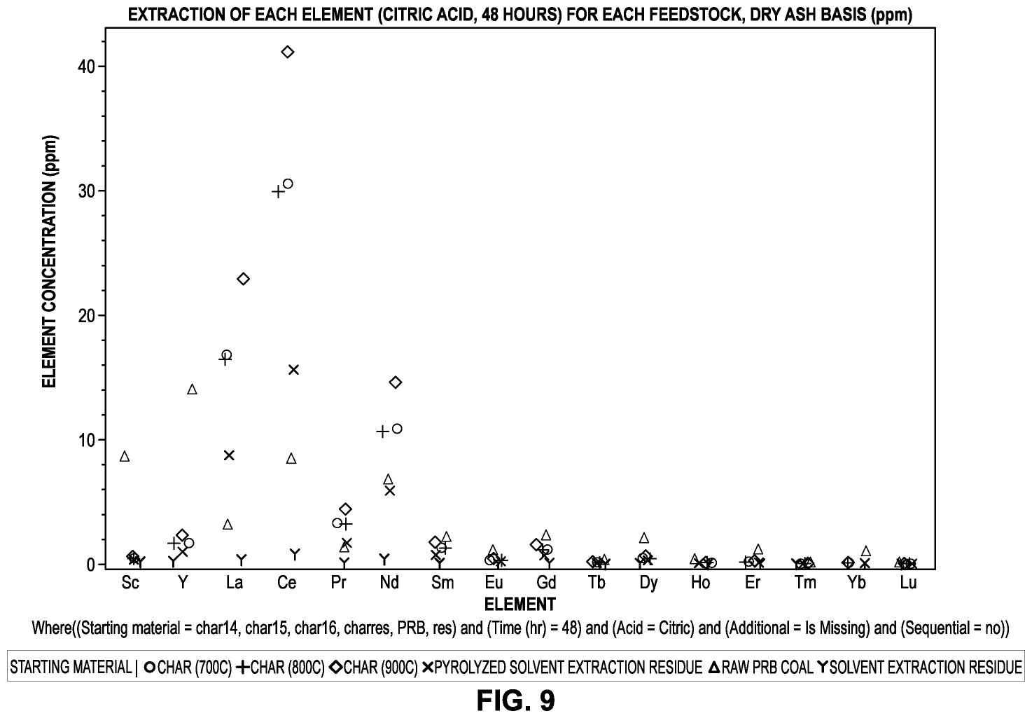

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the invention.

As used herein, the term “rare earth elements” (REEs) refers to the lanthanide metals, a series fifteen metallic elements from lanthanum to lutetium, and additionally scandium and yttrium. Scandium and yttrium are considered rare-earth elements because they tend to occur in the same ore deposits as the lanthanides and exhibit similar chemical properties, despite having different electronic and magnetic properties compared with the lanthanides. Thus, the REEs are scandium, yttrium, lanthanum, cerium, praseodymium, neodymium, promethium, samarium, europium, gadolinium, terbium, dysprosium, holmium, erbium, thulium, ytterbium, and lutetium.

As used herein, the term “heavy rare earth elements” (HREEs) refers to rare earth elements having an atomic number greater than or equal to 66. HREEs include, for example, dysprosium, holmium, erbium, thulium, ytterbium, and lutetium.

As used herein, the term “light rare earth elements” (LREEs) refers to rare earth elements having an atomic number less than or equal to 64. LREEs include, for example cerium, neodymium and lanthanum.

As used herein, the term “rare earth extract” refers to the liquid product of a solid-liquid extraction of a coal-based intermediate via weak acid.

As used herein, the term “coal-based intermediate product” refers to a coal product which has undergone one or more physical and/or chemical transformations that distinguishes it from raw coal or fly ash (the product of combustion), and primes it for weak-acid REE extraction. Combusted coal products e.g., fly ash, are generally not considered coal-based intermediates as the combustion process tends to lock the REEs in a glassy phase of the fly ash, making them inaccessible to weak acid leaching and defeats a purposeful objective of using sustainable chemistry.

As used herein, the term “weak acid” refers to an acid that doesn't completely dissociate in solution. In other words, a weak acid is any acid that is not a strong acid. While a weak acid is not necessarily an organic acid, examples of weak acids include citric acid, acetic acid, formic acid, lactic acid, or any combination thereof. The weak acids constitute sustainable chemical solutions which are not necessarily manufactured through conventional petro-chemical means.

As used herein, the term “oxidizer” refers to a substance in a redox chemical reaction that gains or “accepts” an electron from a reducing agent (called the reductant, reducer, or electron donor). In other words, an oxidizer is any substance that oxidizes another substance. Useful oxidizers of the disclosed systems and methods include ozone, hydrogen peroxide and combinations thereof.

As used herein, the term “dewatering and devolitizing” the coal feedstock refers to a process whereby respectively water is removed from a coal feedstock to a dryness of less than 3% water and organic material such as hydrocarbons in all forms are removed, to substantially leave a coal intermediate feedstock possessing a fixed carbon content of greater than 85% with the vast remainder being mineral matter remaining which was present in the mined coal before being processed into the feedstock intermediate, and associated REEs.

As used herein the term “pyrolyzing” a coal feedstock refers to a process whereby a coal feedstock is exposed to mild thermal treatments compared to temperatures associated with combustion, typically the coal feedstock being heated to temperatures between 480 deg C. and 1300 deg C. in the absence of oxygen. In some embodiments, pyrolysis may involve addition of an oxygen-free inert or hydrogen-containing gas such as argon, nitrogen, methane, or pure hydrogen. In some embodiments, pyrolysis may begin with sealing off a pyrolysis vessel from the ambient atmosphere and driving off the residual oxygen from the air that was initially trapped in the vessel.

### DETAILED DESCRIPTION OF THE INVENTION

In the following description, numerous specific details of the processes, systems and methods of the present invention are set forth in order to provide a thorough explanation of the precise nature of the invention. It will be apparent, however, to those of skill in the art that the invention can be practiced without these specific details.

### Nature of REE in Available Coal Resources

Taggart, et al.² surveyed rare earths contained in U.S. coal ash. In addition to total rare earth content, Taggart, et al. measured the extractable rare earth content. Because of high coal combustion temperatures, the ash particles tend be glassy and/or vitrified, which makes rare earths difficult to extract from ash and/or requires use of strong corrosive and hazardous strong acids, e.g., hydrofluoric, nitric and hydrochloric acids alone or in combination. The extraction technique used concentrated (15 molar) nitric acid, and the ash/acid mixture was heated to 85-90 C for four hours. Ash from Appalachian coals had the highest total rare earth content, 591±91 ppm, versus 337±69 ppm for Powder River Basin (PRB) ash. On the other hand, only 30% of the Appalachian REE could be extracted, versus 70% of the PRB REE, so the total quantity of extractable REE was not significantly different. Taggart, et al. attributed the higher extractability of PRB ash to its higher calcium content.

More recent work by NETL, Stuckman, et al.³ confirmed the benefit of exploiting coal resources with higher calcium, for REE supply, due to the ease of their extraction.

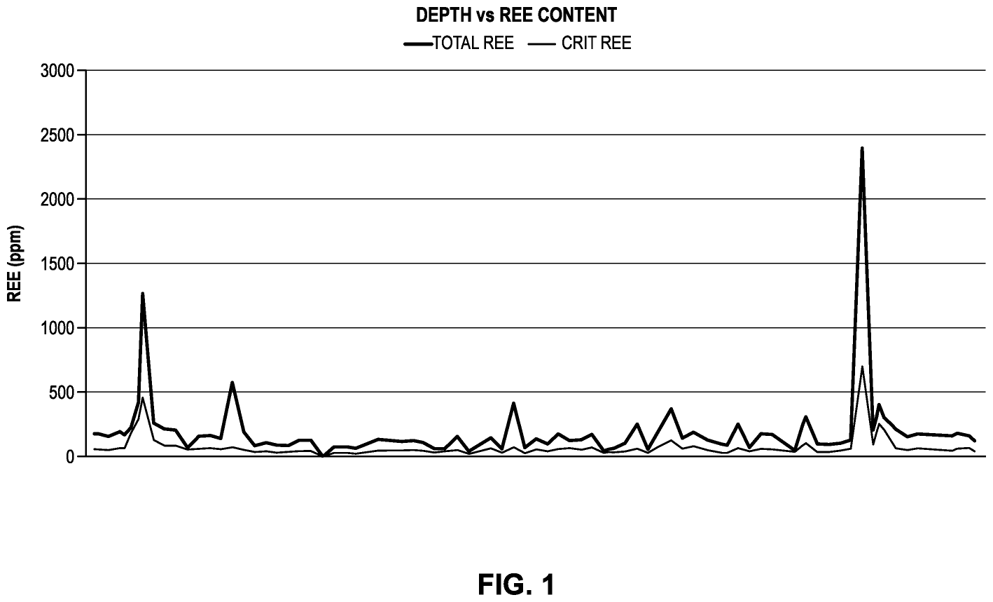

Bagdonas, et al.⁴ measured REE concentration versus depth for a 21 m (70 ft) deep core sample from an undisclosed mine near Gillette, Wyoming, shown in FIG. 1. They noted two types of REE enrichment. Near the top of the coal seam (left side of FIG. 1) and the bottom of the coal seam (right side of FIG. 1), there are bounding layers, each about 1 m (3 ft) thick, containing clay-rich humic materials. These layers have the highest REE concentrations (mineral matter basis) and are enriched in the more valuable heavy REE elements, including a designated group of critical REEs (Nd, Eu, Tb, Dy, Er, and Y). Intermediate level REE enrichments are likely due to inclusion of volcanic ash within the coal, which is enriched in the less valuable light rare earths.

Under the current state of the prior art, in addition to fly and bottom ash recovered after coal is combusted, there are large quantities naturally occurring REEs in coal mine wastes (e.g. recovered over/under burden and grey coal), together with coal mine tailings. PRB coal is not beneficiated/processed at the mine to reduce its mineral content. Instead, selective mining techniques are used to assure the quality of the coal recovered e.g., minimizing the non-carbon constituent content of the coal, such as leaving mineral and non-combustible matter behind. As a result, during mining the coal which is sold, a residual grey coal is reserved. This grey coal consists of coal with a relatively high mineral and non-combustible matter content. While some of this grey coal can be blended into the produced coal—as saleable product, if the maximum ash and minimum heating value specifications can be met, most of it simply accumulates at the mine site. Eventually this grey coal may be used to reclaim mined-out coal areas as part of land restoration programs.

For rare earth production, the top or bottom bounding layers that surround the coal-rich seams (aka, “underburden and overburden”), could be selectively mined. Alternatively, rare earth could be produced from the grey coal pile. This pile would have less REE concentration than the selectively mined layers but would avoid additional mining costs. REE extraction from grey coal could be integrated into a mine reclamation process. Alternatively, grey coal and over and under burden containing high concentrations of REEs could be purposefully mined alone, if economically feasible. Alternatively, grey coal and over and under burden resources could be mined with the coal and these ingredients separated before the high carbon content coal is used/sold for thermal duties and the lower carbon content resources fed into a REE extraction and recovery facility.

### Example 1: Leaching REEs from Unburned, Whole Coal

Rather than leaching REEs from coal ash, REEs can be leached from coal and coal wastes that are not subject to combustion. An advantage of this approach is that the REEs are removed before the coal minerals are exposed to high temperatures, converting them to glassy vitrified materials, which are known to be difficult to recover, and require aggressive, hazardous and non-environmentally friendly solvents and chemicals. Coals can be very porous materials, although most of the pores are too small to be seen by the naked eye. Sub-bituminous coals such as that mined in the powder river basin (PRB) in Wyoming, contain high oxygen contents and develop porous structures as a result of solvent extraction to recover organic material and or that are subject to mild thermal treatment such as pyrolysis whereby organic material is volatilized and driven off as an emissions stream, either as a hydrocarbon liquid or gas. Leach liquors can access the mineral matter in coal particles via the pore structure, which is especially beneficial, during the process of REE extraction and recovery.

Cordero Rojo coal samples (which is a high oxygen content sub-bituminous coal, mined in the Wyoming PRB) were evaluated by Yoon and co-workers at Virginia Tech for leaching tests⁸ with 1 M HCl. The tests were done at room temperature to 50 C for 0.5 to 4 hours.

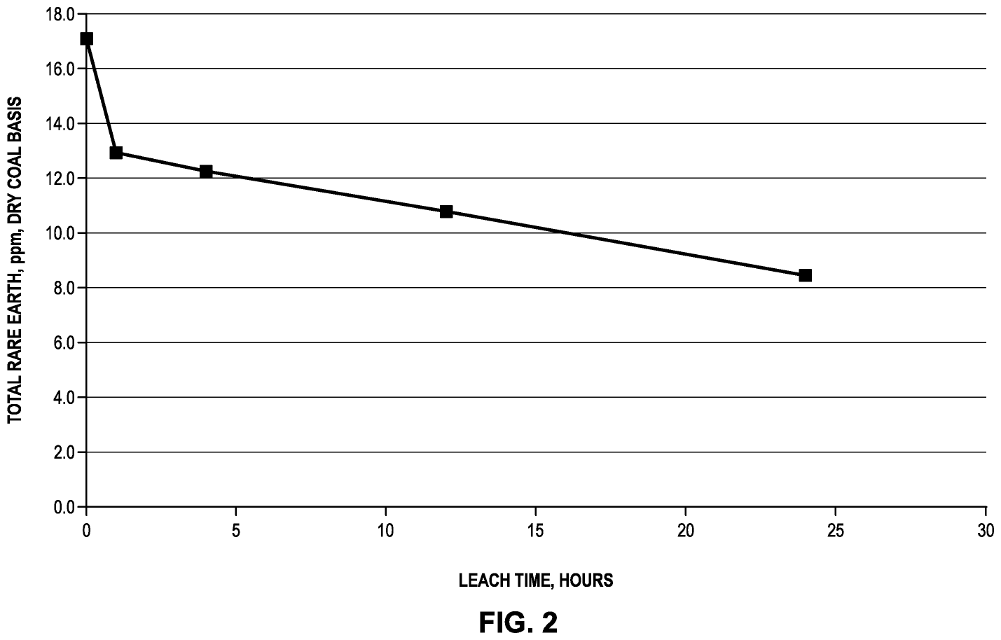

As shown in Table 1, less than 3% of the REEs were extracted. Longer leaching tests were⁹ then conducted at room temperature, also with Cordero Rojo coal and 1 M hydrochloric acid. FIG. 2 shows the REEs remaining in the solids as a function of time.

TABLE 1
REE leaching tests with Cordero Rojo coal and hydrochloric acid.

| Test condition | TREE/(ug/g) | Recovery/(%) |
|---|---|---|
| 1M HCl leaching for 0.5 hr | 4.60 | 1.381 |
| 1M HCl leaching for 1.0 hr | 5.36 | 1.609 |
| 1M HCl leaching for 2.0 hr | 6.13 | 1.841 |
| 1M HCl leaching for 4.0 hr | 8.64 | 2.594 |
| 1M HCl leaching for 1.0 hr room temp. | 5.36 | 1.609 |
| 1M HCl leaching for 1.0 hr 40° C. | 7.46 | 2.240 |
| 1M HCl leaching for 1.0 hr 50° C. | 9.84 | 2.955 |
| Coal prior to leaching | 333.05 | |

With increasing leaching time, the fraction of REEs extracted increased. About half of the REEs were removed at the maximum leach time, 24 hours.

The data in Table 1 shows that higher temperatures only slightly increased REE removal rates. From FIG. 2, it is shown that REEs can be leached from unburned, whole coal, but very long leach times are required. This suggests a mass-transfer limited process. This seems reasonable, since liquid phase diffusion through the coal pore structure is expected to be a slow process.

The long leach times plus the low REE concentrations in the extracted acid solution, in unburned coal means that it is unlikely that this approach will neither be industrially practical nor economically compelling. To achieve reasonable leach times, the organic fraction of the coal needs to be removed to reduce or eliminate mass transfer restrictions. Furthermore, the removal of the organic fraction needs to occur at relatively low temperatures (compared to combustion) to prevent conversion of the mineral matter into glassy materials, in which it is known any resident REEs are difficult, uneconomic to extract, and then only by using strong hazardous and non-environmentally friendly strong acids.

### Example 2: REE Extraction of a Pyrolyzed and Solvent Extracted Coal-Based Intermediate

The feed coal is dried (water removed), sized, and then fed to a solvent extraction process. This produces an extract containing largely hydrocarbon material, and a residual (un-extracted solids) which has a high mineral content and contains the REE″s. A small gas byproduct stream is also produced, which is mainly carbon dioxide. The residual consisting largely of mineral matter to which REEs are attached, is pyrolyzed to produce liquids, gas, and a char product, in which enriched concentrates of REEs exist. Alternatively, the solvent residue alone may be used as a feedstock for REE extraction directly, however surface treatment to remove remnant organic material and changes to the surface characteristic to allow direct extraction may be necessary e.g., using butanol, ethanol or methanol.

The process integrates thermal pyrolysis with solvent extraction, with any resultant CO2 produced (from the solvent extraction and/or pyrolysis processing), captured and responsibly managed to avoid entry into the atmosphere e.g. conversion via dry methane reforming into synthesis gas from which petrochemicals are manufactured or stored underground in spent oil and gas fields or used as a motive for enhancing crude oil production or converted into mineral based (carbonate type) construction materials such as building blocks. An exemplary process for producing a pyrolyzed and solvent extracted coal-based intermediate is described in PCT Pat. App. No. WO 2019/055529, the contents of which are hereby incorporated by reference. The material left behind by this process, the pyrolyzed and/or solvent extracted residual can be high in fixed carbon content and/or contains rich quantities of mineral matter which REEs may reside and in some embodiments therefore may serve as a suitable coal-based intermediate product from which to extract REE.

During solvent extraction, essentially all of the mineral matter remains in the residual product. When this residual is pyrolyzed, essentially all of the mineral matter remains in the char. This means that the residual is a richer source of rare earths than the feed coal, and the char is a richer source of rare earths than the residual. The concentrations of REEs in residuals or char will be similar in quantity as present in post-combustion ash, but the temperatures used in solvent extraction and pyrolysis are not high enough to convert the coal mineral matter to glassy materials, making REE extraction from these coal intermediates more viable.

Table 2 shows surface area measurements for chars produced from pyrolyzing residue remaining after coal solvent extraction experiments. The chars produced from solvent extraction residuals have BET surface areas that are about an order of magnitude larger than surface areas of chars produced from unextracted coals. This shows that these solids have a much more open, porous structure that may pose less of a mass transfer resistance when extracting REEs with weak acids than whole coal. In these preliminary experiments, extract yield (recovery of organic and hydrocarbon material) was about 40 wt. %. In more recent experiments, extract yields have increased to 84 wt. % (typical) with yields as high as 95 wt. %, meaning that most of the fixed carbon fraction of the coal has been removed, leaving the REEs associated with mineral matter in a more concentrated form in the residual, which are easier to contact and extract.

TABLE 2
Surface areas of chars produced from solvent extraction
residual and unextracted coals. From Schaffers, et al.¹¹

| | Surface Area (m²/g) | | | | | |
|---|---|---|---|---|---|---|
| | Coal | Residue | Coal | Residue | Coal | Residue |
| | Char | Char | Char | Char | Char | Char |
| Method | (833° C.) | (833° C.) | (900° C.) | (900° C.) | (975° C.) | (975° C.) |
| BET (N₂) | 0.36 | 10.81 | 1.49 | 24.39 | 34.54 | 40.25 |
| (Mesopores) | | | | | | |
| D-R (CO₂) | 408.51 | 382.13 | 341.44 | 382.61 | 344.68 | 404.13 |
| (Micropores) | | | | | | |

In some embodiments the pyrolysis plus solvent extraction process may be fed with enriched PRB coal and/or grey coal and/or over and under burden (“Coal Wastes”) to produce a coal-based intermediate product. The Coal Waste could be either material from the grey coal pile or selectively mined material from the upper or lower coal seam bounding layers (coal seam over burden or under burden). Most of the organic fraction of the coal is then be removed from the coal by either solvent extraction or pyrolysis alone or a combination of solvent extraction and pyrolysis. Since the solvent extraction or pyrolysis temperatures are not high enough to form glassy minerals, in some embodiments, the REEs may be leached from either the solvent extraction residual or the pyrolysis char using a weak acid.

### REFERENCES CORRESPONDING TO EXAMPLES 1 AND 2

1. U.S. Department of Energy, Report on Rare Earth Elements from Coal and Coal Byproducts, Report to Congress, January 2017.
2. Ross K. Taggart, James C. Hower, Gary S. Dwyer, Heileen Hsu-Kim, Trends in the Rare Earth Element Content of U.S.-Based Coal Combustion Fly Ashes, Environmental Science & Technology, vol. 50, pp. 5919-5926, 2016.
3. M. Stuckman, C. Lopano, B. Hedin, B. Howard, E. Granite, Characterization and Recovery of Rare Earth Elements from Powder River Basin Coal Ash, 2019 International Pittsburgh Coal Conference, Pittsburgh, PA, Sep. 3-6, 2019.
4. Davin A. Bagdonas, Charles Nye, Randall B. Thomas Sr., Kelly K. Rose, Rare Earth Element Occurrence and Distribution in Powder River Basin Coal Core, Wyoming, 2019 International Pittsburgh Coal Conference, Pittsburgh, PA, Sep. 3-6, 2019.
5. Georgiana A. Moldoveanu, Vladimiros G. Papagelakis, Recovery of Rare Earth Elements on Clay Minerals: II. Leaching with Ammonium Sulfate, Hydrometallurgy, vol. 131-132, pp. 158-166. 2013.
6. Georgiana A. Moldoveanu, Vladimiros G. Papagelakis, An Overview of Rare-Earth Recovery by Ion-Exchange Leaching from Ion-Exchange Clays of Various Origins, Mineralogical Magazine, vol. 80, pp. 63-76, 2016.
7. Scott N. Montross, Jonathan Yang, James Britton, Mark McKoy, Circe Verba, Leaching of Rare Earth Elements from Central Appalachian Coal Seam Underclays, Minerals, vol. 10, pp. 577-596, 2020.
8. Roe-Hoan Yoon and co-workers, Virginia Tech, unpublished data, 2019.
9. Ying Wang, Shuai Tan, Zaixing Huang, David Bell, University of Wyoming, unpublished data, 2019.
10. Timothy James Gunderson, Stefan Holberg, Seth Taylor Bassham, Xinyan Wang, Michael Ryan Downey, Jeramie J. Adams, Devang P. Khambhati, David A. Bell, John Fitzgerald Ackerman, Patrick Alfred Johnson, Polyurethanes Derived From Coal Extract, J. Applied Polymer Sci., 2020.
11. William C. Schaffers, Ying Wang, David A. Bell, Gasification of Residue from the Solvent Extraction of Coal, American Institute of Chemical Engineers National Meeting, Nov. 1, 2017.

### Example 3: Weak Acid Extraction

### Methods

All extractions were conducted in 50 mL centrifuge tubes; each experiment performed in triplicate, excluding extraction. Coal-based intermediates used were: (1) pyrolyzed char—the product of using thermal heat to remove organic material leaving behind a high fixed content char intermediate; and (2) a residue that has been solvent extracted at mild temperatures, which has a high fixed carbon and mineral content, the organic molecules having been extracted by the solvent. In both cases for the production of the pyrolysis char and solvent extracted residue intermediate, a raw coal feedstock was prepared by grinding to 0.3-1.65 mm diameter, which was subsequently either pyrolyzed or solvent extracted. These resultant intermediate products being the source material used as the feedstock from which REEs were extracted using weak acids.

Extractions were performed with a 10:1 mass ratio, typically involving either 30 g solution: 3 g coal or 20 g solution: 2 g coal (indicated below), with 20 g and 13.3 g of distilled water used for washing, respectively. Coal feedstocks investigated were weighed into a centrifuge tube, followed by acid, weights recorded, and the tube was capped, wrapped in parafilm, and gently shaken to ensure proper mixing before being transferred to the tube rocker for the allotted time. Upon completion, this tube was centrifuged at 4000 rpm for 10 minutes, and the acid decanted into a new centrifuge tube. A rinse was conducted to ensure most material was to ensure removal of residual REEs from the initial decanting: deionized water was added to the tube still containing the coal, gently shaken, and transferred to the tube rocker for 10 minutes. This tube was again centrifuged for 10 minutes at 4000 rpm, and the water decanted into the tube containing the decanted acid.

To prepare samples for REE determination, inductively coupled plasma-mass spectrometry (ICP-MS) was deployed. From each determination, 0.5 g±0.15 g solution was drawn from the tube containing the mixture of decanted acid and distilled water and filtered through a 0.4 μm filter into a 15 mL NUNC centrifuge tube. 2% nitric acid (HNO₃) was added to reach a total mass of 10 g±0.25 g.

Standards for ICP-MS analysis were prepared using INORGANIC VENTURES CMS-1 Rare Earth ICP-MS Standard in nitric acid. Standards ranged from ˜100 ppb to ˜1.2 ppb.

Percent yields were determined by comparing ICP-MS results of extracted REE concentrations to those found via lithium metaborate fusion and acid digestion of Cordero Rojo ash.

### Characterization of Raw Coal and Coal Byproducts

REE content of the raw coal source and byproducts was determined via borate fusion and acid digestion. All samples were first ashed in a LECO TGA 801, then and fused with lithium metaborate (99% trace metal grade) in a muffle furnace at 1000° C. for 30 minutes. Each sample was then dissolved in 100 g of 20% HNO₃. Each of these samples were analyzed via ICP-MS.

### Varying Acids and Residence Times

Extractions were conducted using acetic, ascorbic, citric, formic, and lactic acid at varying time intervals with 30 g±0.3 g acid and 3 g±0.1 g coal. Acetic, citric, formic, and lactic acid were at a consistent concentration of 1.5 M, while ascorbic acid was at saturation (˜0.33M). All acids were tested at residence times of 1 hr, 2 hr, 24 hr, 48 hr, 2 days, 4 days, and 7 days. Citric acid alone also includes data points for 12 hr and 36 hr.

### Varying Temperatures

A tube heater was placed on a shaker in a laboratory hood for these experiments. A thermocouple was placed in one of the tube slots to verify that temperature was maintained. Because heating required a different agitation method than all other experiments, a control experiment was done at ambient temperature for comparison. Experiments were conducted with 20 g±0.2 g citric acid and 2 g±0.1 g coal sample, with 2-day residence time at 75° C. and 50° C.

### Varying Particle Size

Coal was crushed and sized to large (>0.850 mm), medium (0.417-0.850 mm), and small (<0.417 mm) particle sizes, then 3 g±0.1 g of coal was extracted with 30 g±0.3 g of citric acid for 1 hr.

### Varying Mass Ratio

30 g of 1.5M citric acid for a series of experiments using 2.5 g, 2.0 g, 1.5 g, 1.0 g, and 0.5 g of coal to determine if the amount acid used in the main panel of experiments limited the yield. Experiments were conducted at room temperature for 1 hour.

### Comparison Between Feedstocks

Different coal byproducts were tested to determine efficacy of extraction from possible coal intermediates. Samples of 3 g±0.05 g each of char from coal pyrolyzed at 700° C., 800° C., and 900° C. and residue from a coal solvent extraction scheme were extracted using 30 g±0.08 g of 1.5 M citric acid for 48 hours. Some of the residue from the solvent extraction pilot plant was further pyrolyzed and tested using 2 g±0.005 g of this char and 20 g±0.005 g of 1.5 M citric acid for 48 hours.

### Results

Neodymium (Nd), europium (Eu), terbium (Tb), dysprosium (Dy) and yttrium (Y) were selected as the critical rare earth elements (CREEs) of interest for extractability and acgieved recovery is presented in Table 3. Tables 4 to 8 inclusive reveal other performance characteristics related to extraction of REEs from coal char samples.

TABLE 3
Percent recovery of Critical Rare Earth Elements (CREES).

PERCENT RECOVERY OF CREES

| ACID | 1 hr | 2 hr | 24 hr | 48 hr | 4-day | 7-day |
|---|---|---|---|---|---|---|
| ACETIC | 0.86 | 0.85 | 1.26 | 1.35 | 1.33 | 1.36 |
| CITRIC | 12.64 | 10.31 | 18.74 | 22.30 | 26.92 | 26.35 |
| FORMIC | 3.02 | 3.44 | 5.62 | 6.32 | 6.57 | 6.68 |
| LACTIC | 8.54 | 8.44 | 18.93 | 22.14 | 20.67 | 22.74 |

TABLE 4
Percent Recovery of Total Rare Earth Elements (TREES).

PERCENT RECOVERY OF TREES

| ACID | 1 hr | 2 hr | 24 hr | 48 hr | 4-day | 7-day |
|---|---|---|---|---|---|---|
| ACETIC | 0.52 | 0.51 | 0.74 | 0.78 | 0.77 | 0.78 |
| CITRIC | 8.56 | 6.91 | 12.67 | 14.91 | 17.56 | 17.96 |
| FORMIC | 1.75 | 1.94 | 3.05 | 3.43 | 3.57 | 3.65 |
| LACTIC | 5.40 | 5.33 | 12.29 | 14.49 | 13.63 | 15.11 |

TABLE 5
Percent recovery of Heavy Rare Earth Elements
(HREEs) of citric and lactic acid.

PERCENT RECOVERY OF HREES

| ACID | 1 hr | 2 hr | 24 hr | 48 hr | 4-day | 7-day |
|---|---|---|---|---|---|---|
| CITRIC | 13.88 | 11.16 | 20.79 | 22.25 | 28.01 | 30.52 |
| LACTIC | 10.08 | 10.09 | 22.96 | 26.72 | 25.26 | 27.47 |

TABLE 6
TREE Percent recovery of particle size variation.

| | |
|---|---|
| PARTICLE SIZE | TREE PERCENT RECOVERY |

| | | |
|---|---|---|
| ≥0.850 | MM | 3.76 |
| 0.417-0.850 | MM | 5.78 |
| <0.417 | MM | 8.19 |

TABLE 7
Temperature effect (citric acid, 48 hr extraction).

| TEMPERATURE | TREE PERCENT YIELD |
|---|---|
| 75° C. | 36.17 |
| 50° C. | 18.26 |
| AMBIENT (~20° C.) | 11.16 |

TABLE 8
Percent recoveries of each feed.

| | % LREE | % HREE | % TREE |
|---|---|---|---|
| Material | Recovery | Recovery | Recovery |
| Raw PRB Coal | 9.78 | 23.94 | 12.44 |
| Char (700° C.) | 14.10 | 3.78 | 12.77 |
| Char (800° C.) | 20.00 | 3.66 | 17.03 |
| Char (900° C.) | 30.91 | 5.43 | 26.08 |
| S.E. Residue | 0.59 | 0.43 | 0.55 |

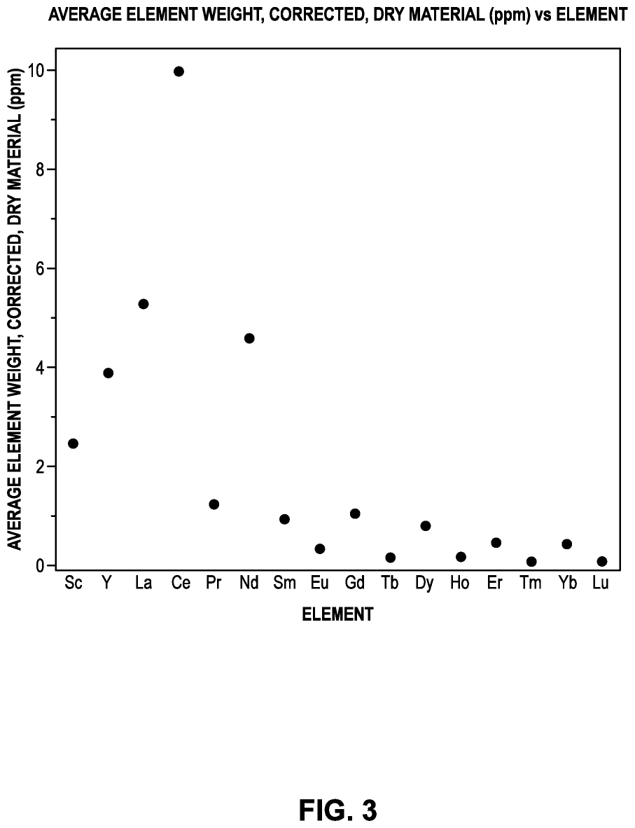

As can be seen, the Cordero Rojo coal is particularly enriched in cerium, lanthanum, and neodymium (FIG. 3). While heavier REEs are present, elements from samarium to lutetium see little representation.

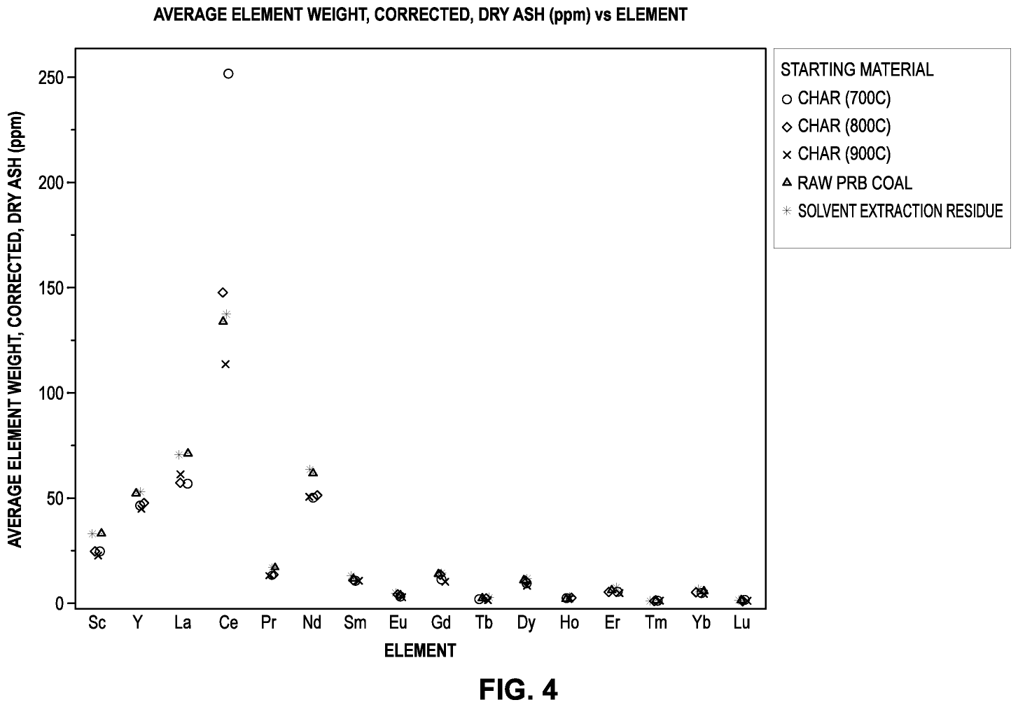

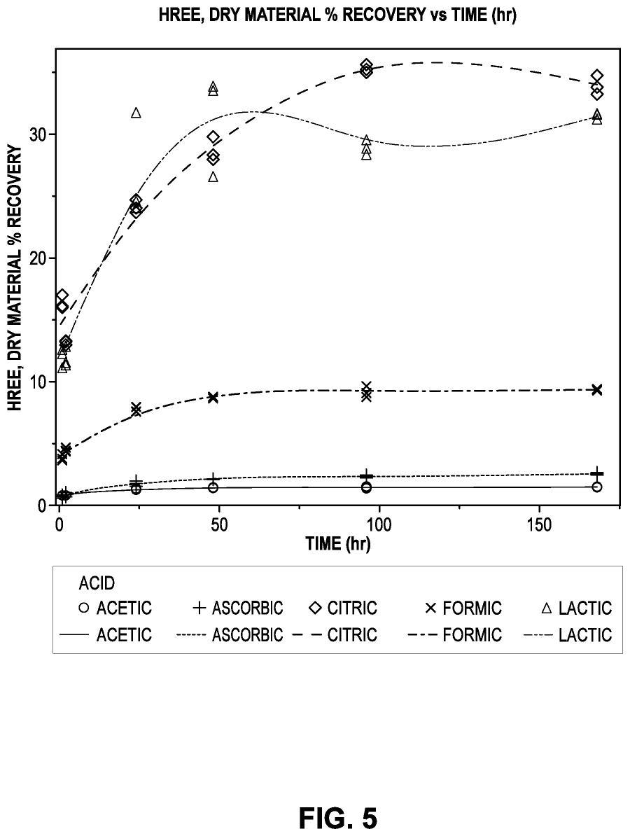

Extraction efficiency increased with greater residence time for most acids. Extraction via ascorbic acid was only slightly above the method detection limit and was thus excluded from reported results. Acetic acid does show some extraction, marginally superior than ascorbic acid. Effectiveness of all acids plateau after about 48 hrs (FIG. 4), with only a slight increase from 48 hrs to 7 days. Citric acid and lactic acid out-performed all other acids, with citric acid performing slightly better than lactic acid in the full 7-day experiments. Lactic acid did however outperform citric acid in extracting heavier REEs across the 48 hrs time frame. (FIG. 5).

Extraction yield increased with decreasing char particle size (and thus increased surface area: volume ratio) indicating an external mass transfer limitation. Extraction yield was wholly unchanged by varying the solvent to coal ratio; this seems to imply that the lowest solvent ratio is substantially in excess, and therefore increasing it does not improve yield.

Citric acid and lactic acid performed similarly overall before passing the 48-hour mark, at which point citric acid significantly surpassed the effectiveness of lactic acid.

Taking heavy rare earth elements (HREEs) to be dysprosium, holmium, erbium, thulium, ytterbium, and lutetium, citric acid performed better than lactic acid until the 24 hr point, at which time lactic acid surpassed citric acid's percent yield until the 4-day point.

Char particle size did have a significant effect on extraction efficiency, predictably improving yield with decreasing particle size. As seen in FIG. 5, smaller particle sizes consistently yielded greater extraction.

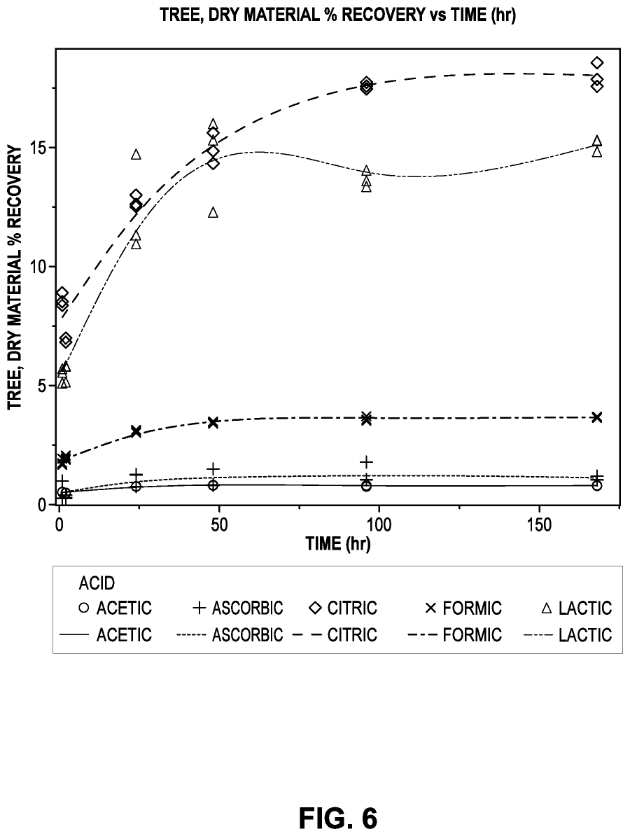

Varying temperature experiments were conducted with 1.5M citric acid for 48 hours. Because the setup deviated from the standard rocker used in the other experiments, an ambient experiment was included for reference. At 75° C. (labeled “hi” in FIG. 6), the percent yield was over double the percent yield of 7-day ambient experiments on the rocker. The ambient experiment performed in the heater/shaker setup was slightly less than that of the 48-hour setup in the rocker (see Table 4).

### Varying Feedstocks

Table 8 summarizes the percent yields for each of the various feedstocks. The data are separated into percent yields of light rare earth elements (LREEs), HREEs, and TREEs. Citric acid was more effective at removing HREEs from the raw coal sample, averaging 23.94% recovery in a 48-hour extraction, as opposed to 3.78-5.43% recovery from char samples. LREEs, however, were more efficiently removed from the char samples, ranging from 14.10-30.91% recovery. The temperature at which the coal was pyrolyzed also seems to have an effect, with REE recovery nearly doubling for char processed at 900° C. compared to 700° C.

Tests on the solvent extracted residue returned REE recovery values only slightly above the method detection limits for most elements. It is possible that the solvent was not completely removed from the coal's surface, preventing complete saturation of the coal with the acid. During extraction, after 48 hours of soaking in the acid, many particles continued to float at the top of the solution, indicating incomplete saturation. To further examine this effect, a sample of this solvent extracted coal was pyrolyzed and subjected to the same acid treatment. This sequence does not appear to enhance recovery of REEs as the extraction was comparable to that of the raw coal.

### CONCLUSIONS

Of all the acids evaluated, citric acid and lactic acid were the most effective at extracting rare earth elements, with lactic acid having a greater short-term extraction efficiency on heavier rare earth elements. Long term, however, citric acid still surpassed lactic acid overall. The extraction performed by ascorbic acid was below the method detection limit, and thus concluded to be an ineffective agent for recovering REE from char feedstocks. Acetic and formic acid did have an effect which was significantly less than that of lactic and citric acid, and were thus excluded from future experiments. Decreasing particle size improved extraction efficiency, as well as increased temperature. It is likely that 10:1 solvent to coal is already in significant excess, as increasing this mass ratio had no discernible effect.

Because the apparatus for the varying temperature experiments was different from the standard rocker testing protocol, an ambient experiment was included. By comparison, the shaker approach used was slightly less effective than the rocker setup. However, the shaker experiment conducted for 48 hours at 75° C. was over twice as effective as the 7-day experiment, in terms of REE extraction impact. In some embodiments, adding a heating method to the rocker design may improve the yield further.

### EMBODIMENTS AND COMBINATIONS

Embodiment 1. A method of extracting rare earth elements from coal, the method comprising:
preparing a coal-based intermediate product, which has not been generated through the process of combustion;
contacting the coal-based intermediate product with a weak acid; and
extracting at least some rare earth elements from the coal-based intermediate product via the weak acid to produce a rare earth extract.

Embodiment 2. The method of embodiment 1, wherein preparing the coal-based intermediate product comprises pyrolyzing a coal feedstock.

Embodiment 3. The method of embodiment 2, wherein preparing the coal-based intermediate product comprises dewatering and devolitizing the coal feedstock.

Embodiment 4. The method of any of the preceding embodiments, wherein preparing the coal-based intermediate product comprises:
contacting the coal feedstock with a solvent to form a solvent extract and a residual material; and
pyrolyzing the residual material to form the coal-based intermediate product.

Embodiment 5. The method of any of the preceding embodiments wherein preparing the coal-based intermediate product comprises solvent extraction to remove organic material leaving behind a low carbon content, mineral and REE rich residual.

Embodiment 6. The method of embodiment 5, wherein the solvent is an organic solvent

Embodiment 7. The method of any of the previous embodiments, wherein pyrolyzing the coal feed comprises heating the coal feed in the absence of oxygen to a temperature of 380 to 1200° C.; or 400 to 1000° C.; or 400 to 900° C.

Embodiment 8. The method of any of the previous embodiments, wherein the weak acid is an organic acid.

Embodiment 9. The method of any of the previous embodiments, wherein the weak acid comprises citric acid, acetic acid, formic acid, lactic acid, or any combination thereof.

Embodiment 10. The method of any of the previous embodiments, wherein the weak acid is citric acid.

Embodiment 11. The method of any of the previous embodiments 9, comprising:
concomitant to contacting the coal-based intermediate product with the weak acid, contacting the coal based intermediate product with an oxidizer.

Embodiment 12. The method of embodiment 12, wherein the oxidizer comprises ozone or hydrogen peroxide.

Embodiment 13. The method of embodiment 1, wherein preparing the coal-based intermediate product comprises processing a coal feedstock.

Embodiment 14. The method of embodiment 13, wherein the coal feedstock comprises subbituminous coal.

Embodiment 15. The method of embodiment 13 or 14, wherein processing the coal feedstock comprises mechanically reducing a particle size of the coal feedstock.

Embodiment 16. The method of embodiment 13, wherein processing the coal feedstock comprises mechanically reducing the particle size of the coal feedstock to a range of 10 microns to 1 millimeter.

Embodiment 17. The method of any of the preceding embodiments, comprising:
concomitant to contacting the coal-based intermediate product with the weak acid, agitating the coal-based intermediate product and the weak acid.

Embodiment 18. The method of any of the preceding embodiments, wherein contacting the coal-based intermediate product with the weak acid occurs at a temperature from 60 to 150° C.

Embodiment 19. The method of embodiment 2, wherein the weak acid is a second weak acid, wherein the rare earth extract is a second rare earth extract, the method comprising:
prior to pyrolyzing the coal feedstock, contacting the coal feedstock with a first weak acid; and
extracting at least some rare earth elements from the coal feedstock via the first weak acid to produce a first rare earth extract.

Embodiment 20. The method of claim 2, wherein the weak acid is a mixture of two different weak acids, wherein the rare earth extract is a second rare earth extract, the method comprising:
prior to pyrolyzing the coal feedstock, contacting the coal feedstock with a first weak acid; and
extracting at least some rare earth elements from the coal feedstock via the first weak acid to produce a first rare earth extract.

Embodiment 21. The method of embodiment 19 or 20, wherein heavy rare earth elements (HREEs) are preferentially extracted into the first rare earth extract, and wherein light rare earth elements (LREEs) are preferentially extracted into the second rare earth extract.

Embodiment 22. The method of embodiment 21, wherein HREEs include dysprosium, holmium, erbium, thulium, ytterbium, and lutetium.

Embodiment 23. The method of embodiment 21, wherein LREEs include cerium, neodymium and lanthanum.

Embodiment 24. The method of embodiment 19 or 20, wherein the first weak acid and the second weak acid are the same.

Embodiment 25. The method of embodiment 19 or 20 wherein the first weak acid and the second weak acid are different.

Embodiment 26. The method of embodiment 19 or 20 wherein two different weak acids are mixed

Embodiment 27. A system for extracting rare earth elements from coal, the system comprising:
a pyrolysis unit configured to heat a coal feedstock in the absence of oxygen;
an extraction vessel, the extraction vessel being configured to:
   receive a coal-based intermediate product, wherein the coal-based intermediate product is not subject to combustion; and
contact the coal-based intermediate product with a weak acid; and
expel a rare earth extract comprising rare earth elements extracted from the coal-based intermediate product.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and sub-combinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Certain molecules disclosed herein may contain one or more ionizable groups [groups from which a proton can be removed (e.g., —COOH) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every device, system, formulation, combination of components, or method described or exemplified herein can be used to practice the invention, unless otherwise stated.

Whenever a range is given in the specification, for example, a temperature range, a time range, or a composition or concentration range or solution strength, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, solvents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by example embodiments and optional features, modification and variation of the concepts herein disclosed may be resorted to by those skilled in the art, and that such modifications and variations are considered to be within the scope of this invention as defined by the appended claims.

1. A method of extracting rare earth elements from coal, the method comprising:
preparing a coal-based intermediate product, which has not been generated through the process of combustion;
contacting the coal-based intermediate product with a weak acid; and
extracting at least some rare earth elements from the coal-based intermediate product via the weak acid to produce a rare earth extract.

2. The method of claim 1, wherein preparing the coal-based intermediate product comprises pyrolyzing a coal feedstock.

3. The method of claim 2, wherein preparing the coal-based intermediate product comprises dewatering and devolitizing the coal feedstock.

4. The method of claim 1, wherein preparing the coal-based intermediate product comprises:
contacting the coal feedstock with a solvent to form a solvent extract and a residual material; and
pyrolyzing the residual material to form the coal-based intermediate product.

5. The method of claim 1 wherein preparing the coal-based intermediate product comprises solvent extraction to remove organic material leaving behind a low carbon content, mineral and REE rich residual.

6. The method of claim 4, wherein the solvent is an organic solvent.

7. The method of claim 1, wherein pyrolyzing the coal feed comprises heating the coal feed in the absence of oxygen to a temperature of 380 to 1200° C.

8. The method of claim 1, wherein the weak acid is an organic acid.

9. The method of claim 1, wherein the weak acid comprises citric acid, acetic acid, formic acid, lactic acid, or any combination thereof.

10. The method of claim 1, wherein the weak acid is citric acid.

11. The method of claim 1, comprising:
concomitant to contacting the coal-based intermediate product with the weak acid, contacting the coal based intermediate product with an oxidizer.

12. The method of claim 11, wherein the oxidizer comprises ozone or hydrogen peroxide.

13. The method of claim 1, wherein preparing the coal-based intermediate product comprises processing a coal feedstock.

14. The method of claim 13, wherein the coal feedstock comprises subbituminous coal.

15. The method of claim 13, wherein processing the coal feedstock comprises mechanically reducing a particle size of the coal feedstock.

16. The method of claim 13, wherein processing the coal feedstock comprises mechanically reducing the particle size of the coal feedstock to a range of 10 microns to 1 millimeter.

17. The method of claim 1, comprising:
concomitant to contacting the coal-based intermediate product with the weak acid, agitating the coal-based intermediate product and the weak acid.

18. The method of claim 1, wherein contacting the coal-based intermediate product with the weak acid occurs at a temperature from 60 to 150° C.

19. The method of claim 2, wherein the weak acid is a second weak acid, wherein the rare earth extract is a second rare earth extract, the method comprising:
prior to pyrolyzing the coal feedstock, contacting the coal feedstock with a first weak acid; and
extracting at least some rare earth elements from the coal feedstock via the first weak acid to produce a first rare earth extract.

20. The method of claim 2, wherein the weak acid is a mixture of two different weak acids, wherein the rare earth extract is a second rare earth extract, the method comprising:
prior to pyrolyzing the coal feedstock, contacting the coal feedstock with a first weak acid; and
extracting at least some rare earth elements from the coal feedstock via the first weak acid to produce a first rare earth extract.

21. The method of claim 19, wherein heavy rare earth elements (HREEs) are preferentially extracted into the first rare earth extract, and wherein light rare earth elements (LREEs) are preferentially extracted into the second rare earth extract.

22. The method of claim 21, wherein HREEs include dysprosium, holmium, erbium, thulium, ytterbium, and lutetium.

23. The method of claim 21, wherein LREEs include cerium, neodymium and lanthanum.

24. The method of claim 19, wherein the first weak acid and the second weak acid are the same.

25. The method of claim 19 wherein the first weak acid and the second weak acid are different.

26. The method of claim 19 wherein the weak acid is a mixture of two different weak acids.

27. A system for extracting rare earth elements from coal, the system comprising:
a pyrolysis unit configured to heat a coal feedstock in the absence of oxygen;
an extraction vessel, the extraction vessel being configured to:
receive a coal-based intermediate product, wherein the coal-based intermediate product is not subject to combustion; and
contact the coal-based intermediate product with a weak acid; and
expel a rare earth extract comprising rare earth elements extracted from the coal-based intermediate product.
